(19) United States
(12) Patent Application Publication
(10) Pub. No.: US 2007/0226643 A1
(43) Pub. Date: Sep. 27, 2007

(54) System and method for controlling obscuring traits on a field of a display

(75) Inventor: William G. Pagan, Durham, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 11/387,501

(22) Filed: Mar. 23, 2006

(51) Int. Cl. G06F 3/048

(52) U.S. Cl. 715/780

(57) ABSTRACT

A method and system in a processing system is disclosed. The processing system includes a display. The method and system comprise providing a field on the display such that its data obscuring characteristics can be altered. Accordingly, a user is allowed to control hiding or obscure data in a field while also allowing for a form developer to indicate the fields behavior upon loading the form.

### FIELD OF THE INVENTION

The present invention relates generally to processing systems and more particularly to a system and method for controlling obscuring traits on a field of a display of a processing system.

### BACKGROUND OF THE INVENTION

Processing systems within a device, such as personal computers, notebooks, laptops, PDAs or even a cell phone, are utilized to fill out forms or fields within the display of such devices. For example, when accessing certain sites on a network a password may be entered into a field to access the site. Furthermore, forms are often times required to access certain information. Typically these forms may require sensitive information such as social security numbers, credit card information, demographic information or the like, that a user may or may not want to be readily seen by others either during the inputting of this information into a field or after the information has been input/entered.

What is needed is a system and method that allows a user to control hiding or obscuring data in a field while also allowing for a form developer to indicate the field's behavior upon loading the forms. The present invention addresses such a need.

### SUMMARY OF THE INVENTION

A method and system in a processing system is disclosed. The processing system includes a display. The method and system comprise providing a field on the display such that its data obscuring characteristics can be altered. Accordingly, a user is allowed to control hiding or obscure data in a field while also allowing for a form developer to indicate the field's behavior upon loading the form.

### BRIEF DESCRIPTION OF THE DRAWINGS

FIG. 1 is a block diagram of a processing system.

FIG. 2 is a flow chart illustrating a method for providing a field with obscuring traits.

FIGS. 3-5 are block diagrans showing a plurality of behavior nodes for the field.

### DETAILED DESCRIPTION

The present invention relates generally to processing systems and more particularly to a system and method for controlling obscuring traits on a field of a display of a processing system. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

A system and method is disclosed which allows a user to control hiding or obscuring data in a field while also allowing for a form developer to indicate the field's behavior upon loading of the form. To describe the features of the present invention in more detail, refer now to the following description in conjunction with the accompanying Figures.

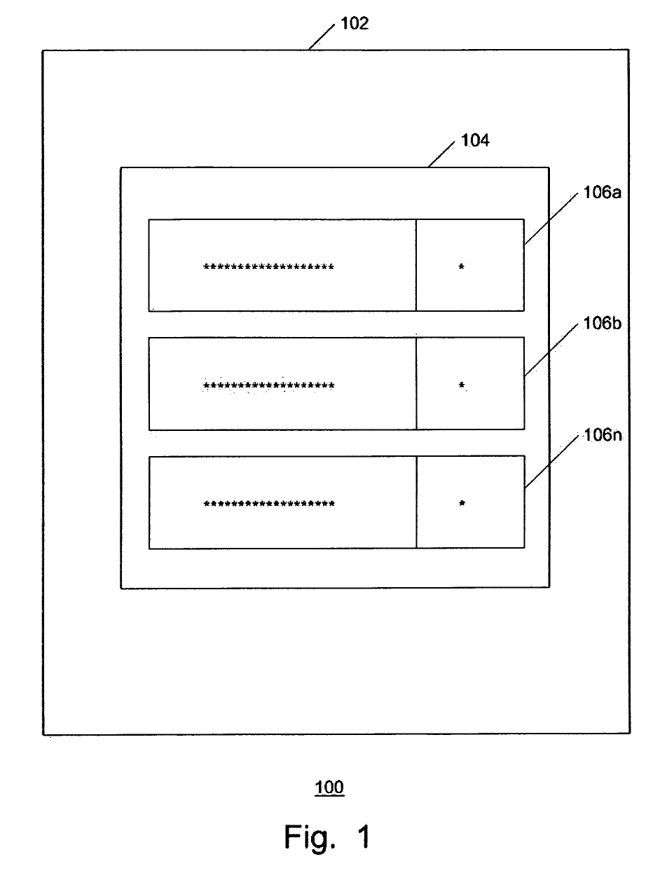

FIG. 1 is a simple block diagram of a processing system 100. The processing system 100 includes a display 102. The display 102 may show a field 104 with one or more entry areas 106. Associated with each entry area 106 is a unified behavior element 108. The behavior element 108 alters the data hiding characteristics of one or a plurality of entry areas 106a-n. What is meant by entry area in the context of the present application is an area where text can be provided. For example, the text could be entered by hand, dragged and dropped into the area, provided by voice input, etc.

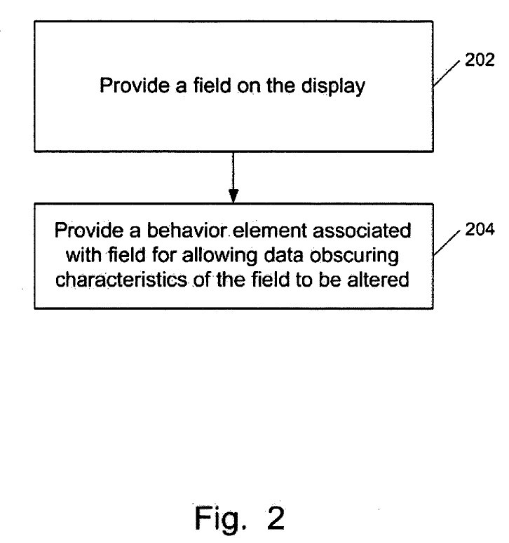

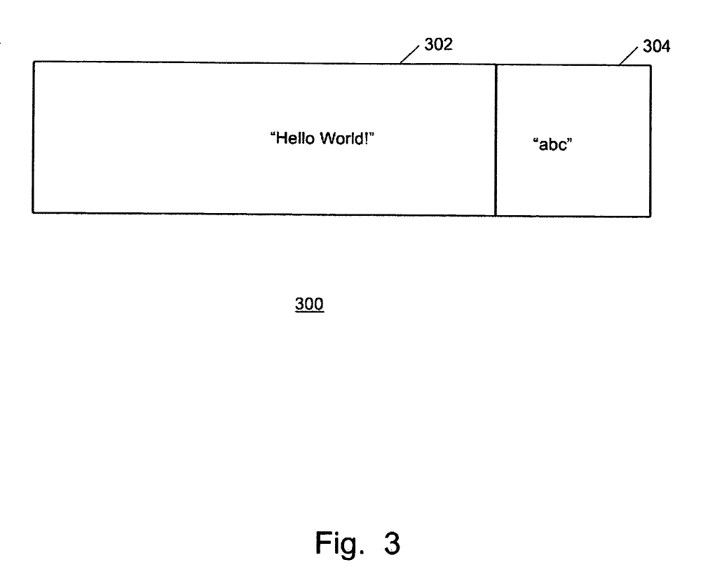

FIG. 2 is a flow chart illustrating a method in accordance with the present invention for providing a field in which the data can be altered to hide the text within the field. First, a field is provided on the display, via step 202. Next, a behavior element associated with the field is provided for allowing data obscuring characteristics of the field to be altered, via step 204. A form designer would be empowered to designate a default or initial mode upon loading of the form and could also execute specific traits if he/she desired. To illustrate this feature, refer now to the following description and FIGS. 3-5.

FIGS. 3-5 are block diagrams showing a plurality of behavior modes for the field. As is seen in FIGS. 3-5, field 300 contains an entry area 302 which may be displayed with an associated behavior element 304. The behavior element 304 controls how the associated entry area 302 will behave in terms of displaying/hiding entered data. Possible behavior modes include free text mode, text protect mode and protect on focus change mode. The behavior element 304 may be controlled by any of or a combination of a mouse, voice activation and touch activation.

FIG. 3 is a block diagram of free text mode. In free text mode, the entry area 302 operates as a normal entry area in which text is displayed and not obscured. This is indicated to the user by the behavior element 304 located on its right side which has a label of “abc”. The behavior element 304 could also be located within the field 300 in other areas next to, above or below the entry area 302.

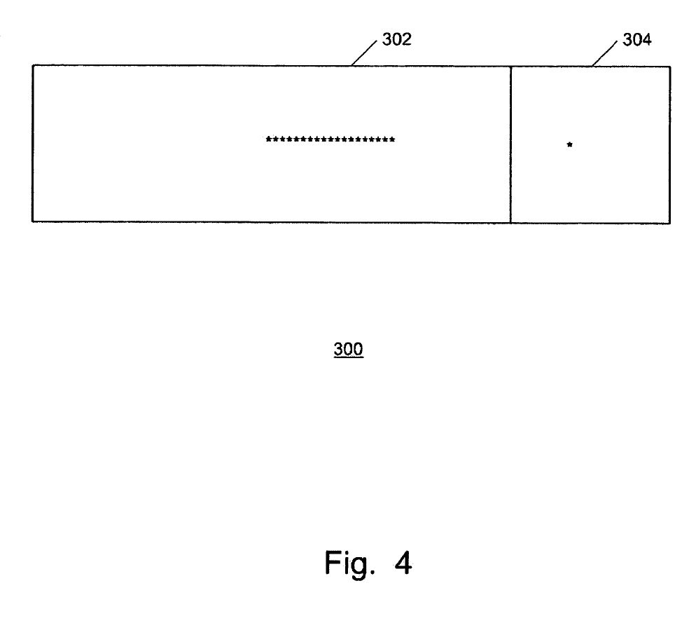

FIG. 4 is a block diagram of text protect mode. In text protect mode, the entry area 302 operates in a fashion similar to a password box, as commonly utilized in computer programs. Text protect mode is indicated to the user by the behavior element 304 attached on its right side, which for purposes of illustration has a label of “*”. The behavior element 304 could also be located within the field 300 in other areas next to, above or below the entry area 302.

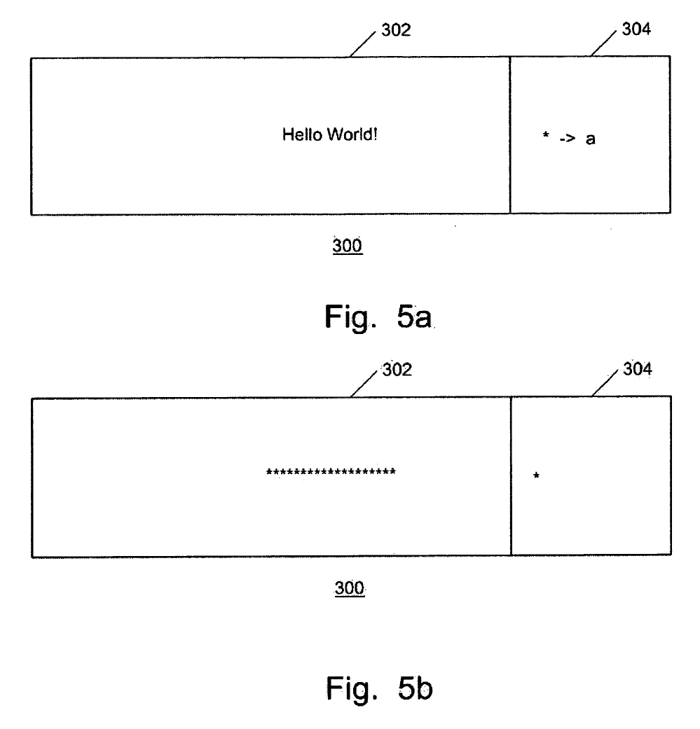

FIGS. 5a-5b show protect on focus change mode. In protect on focus change mode, the entry area 302 will operate normally displaying entered text as shown in FIG. 5a. When the focus is removed, the data within the entry area 302 will be hidden as if it were within a password box, as shown in FIG. 5b. Optionally, when focus is returned, the entered text can remain obscured or can be revealed. This is indicated to the user by the behavior element 304 located on its right side, which has a label of “*→a”. As discussed earlier, the behavior element 304 could also be located within the field 300 in other areas next to, above or below the entry area 302.

In this way, if the user would like to type in their address, telephone number, etc., in a secure manner, they would click on the button to the right to change the behavior of the associated text box. Clicking the behavior button would cycle the components through the various modes.

Additional behaviors beyond text entry traits could be utilized as well in conjunction with the behavior element described in the present invention. For example, the font, the color, or other attribute could be modified based upon a particular mode and that modification would be within the spirit and scope of the present invention.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method in a processing system, the processing system including a display, the method comprising:
providing a field on the display such that its data obscuring characteristics can be altered.

2. The method of claim 1, wherein the data obscuring characteristics are altered by a behavior element associated with an entry area of the field.

3. The method of claim 2 wherein the behavior element provides for a plurality of behavior modes.

4. The method of claim 3 wherein the plurality of behavior modes comprise a normal text mode, a text protect mode and a protect on focus change mode.

5. The method of claim 1 wherein the entry area comprises a text entry area.

6. The method of claim 1 wherein data can be dragged and dropped into the entry area.

7. The method of claim 4 wherein one of the plurality of behavior modes can be specified by a developer as the default behavior mode when the form is first loaded.

8. The method of claim 5 wherein the data can be entered into the entry area.

9. The method of claim 2 wherein the behavior element is controlled by any of or any combination of a mouse, voice activated and touch activated.

10. A system in a processing system, the system comprising:
an entry area; and
a behavior element associated with the entry area, the behavior element for altering the data obscuring characteristics of the entry area.

11. The system of claim 10 wherein the behavior element provides for a plurality of behavior modes.

12. The system of claim 11 wherein the plurality of behavior modes comprise a normal text mode, a text protect mode and a protect on focus change mode.

13. The system of claim 10 wherein the field comprises a text entry area.

14. The system of claim 10 wherein data can be dragged and dropped into the entry area.

15. The system of claim 14 one of the plurality of behavior modes can be specified by a developer as the default behavior mode when the form is first loaded.

16. The system of claim 13 wherein the data can be entered into the entry area.

17. The system of claim 10 wherein the behavior element is controlled by any of or any combination of a mouse, voice activated and touch activated.

18. A computer readable medium with program instructions in a processing system, the processing system including a display, the method comprising:
providing a field on the display such that its data obscuring characteristics can be altered.

19. The computer readable medium of claim 18, wherein the data obscuring characteristics are altered by a behavior element associated with an entry area of the field.

20. The computer readable medium of claim 19 wherein the behavior element provides for a plurality of behavior modes.

21. The computer readable medium of claim 20 wherein the plurality of behavior modes comprise a normal text mode, a text protect mode and a protect on focus change mode.

22. The computer readable medium of claim 18 wherein the field comprises a text entry area.

23. The computer readable medium of claim 18 wherein data can be dragged and dropped into the entry area.

24. The computer readable medium of claim 21 one of the plurality of behavior modes can be specified by a developer as the default behavior mode when the form is first loaded.

25. The computer readable medium of claim 22 wherein the data can be entered into the entry area.

26. The computer readable medium of claim 19 wherein the behavior element is controlled by any of or any combination of a mouse, voice activated and touch activated.

27. A system comprising:
a processing system, wherein the processing system includes a mechanism for providing at least one entry area, and a behavior element associated with the at least one entry area, the behavior element for altering data obscuring characteristics of the entry area.
